(19) United States
(12) Patent Application Publication
(10) Pub. No.: US 2022/0046414 A1
(43) Pub. Date: Feb. 10, 2022

(54) COMMUNICATION DEVICE, AND CONTROL METHOD AND COMPUTER-READABLE MEDIUM STORING PROGRAM FOR COMMUNICATION DEVICE

(71) Applicant: CANON KABUSHIKI KAISHA, Tokyo (JP)

(72) Inventor: Atsushi Minakawa, Kanagawa (JP)

(21) Appl. No.: 17/506,535

(22) Filed: Oct. 20, 2021

Related U.S. Application Data
(63) Continuation of application No. PCT/JP2020/012825, filed on Mar. 24, 2020.

(30) Foreign Application Priority Data
Apr. 22, 2019 (JP) 2019-081068

(51) Int. Cl. H04W 12/047; H04L 29/06; H04W 12/06; H04W 12/03

(52) U.S. Cl. CPC H04W 12/047; H04W 12/03; H04W 12/06; H04L 69/08

(57) ABSTRACT

A communication device determines the version of Device Provisioning Protocol (DPP) supported by another communication device; based on the determined version, determines the type of communication parameter to be provided to this other communication device; and provides information indicating the determined type of communication parameter and a communication parameter corresponding to the type to this other communication device.

### CROSS-REFERENCE TO RELATED APPLICATIONS

This application is a Continuation of International Patent Application No. PCT/JP2020/012825, filed Mar. 24, 2020, which claims the benefit of Japanese Patent Application No. 2019-081068, filed Apr. 22, 2019, both of which are hereby incorporated by reference herein in their entireties.

### BACKGROUND

### Technical Field

The present invention relates to a communication device that provides communication parameters.

### Description of Related Art

In order for a communication device to connect to a wireless network, various communication parameters required in wireless communication, such as a cryptosystem, encryption key, authentication method, and authentication key, need to be set to the communication device. As technology of setting these communication parameters to the communication device, the Wi-Fi Device Provisioning Protocol (hereinafter abbreviated as “DPP”) has been established (PTL 1).

In DPP, there are a device called a configurator that provides communication parameters, and a device called an enrollee that requests and obtains communication parameters. Having obtained communication parameters from the configurator, the enrollee becomes either a station (hereinafter abbreviated as “STA”) or an access point (hereinafter abbreviated as “AP”) in the IEEE 802.11 standard.

When providing communication parameters using DPP, the configurator gives identification information called AKM (Authentication and Key Management) for identifying the type of communication parameters provided.

As the version of DPP is updated and functions are extended in the future, AKM may be appended with a new type. However, even if the configurator provides communication parameters of a type identified by a new AKM type, the enrollee does not always support function extensions, that is, the new version of DPP. The enrollee not supporting such function extensions is unable to recognize the new AKM type in the provided communication parameters, and may wrongly determine the communication parameters as invalid.

Therefore, the enrollee may discard the provided communication parameters, and may not be able to connect to a wireless network.

### CITATION LIST

### Patent Literature

PTL 1 U.S. Patent Application Publication No. 2017/0295448

### SUMMARY OF INVENTION

Various embodiments of the present disclosure provide a communication device that is able to provide, to a partner device, communication parameters of a type according to the version of DPP supported by the partner device.

According to one embodiment, a communication device is provided that includes: a first determination unit configured to determine a version of Device Provisioning Protocol (DPP) supported by another communication device; a second determination unit configured to determine a type of communication parameter to be provided to the another communication device based on the version determined by the first determination unit; and a providing unit configured to provide information indicating the type determined by the second determination unit and a communication parameter corresponding to the type to the another communication device.

Further features of the present invention will become apparent from the following description of exemplary embodiments with reference to the attached drawings.

### BRIEF DESCRIPTION OF DRAWINGS

FIG. 1 is a diagram illustrating an example of the network configuration of a communication system according to each embodiment of the present invention.

FIG. 2 is a diagram illustrating an example of the hardware configuration and the functional configuration of a communication device according to each embodiment.

FIG. 3 is a flowchart illustrating an example of a procedure of a communication parameter providing process executed by the communication device according to each embodiment.

FIG. 4 is a flowchart illustrating an example of a detailed procedure of an AKM setting process in S9 in FIG. 3.

FIG. 5 is a diagram illustrating an example of the operation sequence of an authentication and communication parameter providing process executed between a configurator and an enrollee included in the communication system according to each embodiment.

### DESCRIPTION OF EMBODIMENTS

Hereinafter, an embodiment of the present invention will be described in detail with reference to the accompanying drawings. Note that the embodiment described below is an example as means for realizing the present invention, and modifications or changes shall be appropriately made depending on the configuration of a device to which the present invention is applied or various conditions. The present invention is not construed as being limited to the following embodiment. All combinations of features described in the present embodiment are not necessarily required in a solution of the present invention.

In the present embodiment hereinafter, an example in which communication parameters required in wireless LAN communication are set to a communication device using Wi-Fi Device Provisioning Protocol (DPP) will be described. In DPP here, a communication device that holds communication parameters required in wireless LAN communication functions as a configurator, and provides the communication parameters to another communication device. In contrast, a communication device to which the communication parameters are provided functions as an enrollee, sets the provided communication parameters therein, and connects to a wireless network. The enrollee may operate either as an access point (AP) or a station (STA).

In the present embodiment, an example in which a communication system uses a wireless LAN system conforming to the IEEE (The Institute of Electrical and Electronics Engineers, Inc.) 802.11 series will be described. However, the communication format in the present embodiment is not limited to a wireless LAN conforming to the IEEE 802.11 series, and other communication formats may be used.

Network Configuration in Present Embodiment

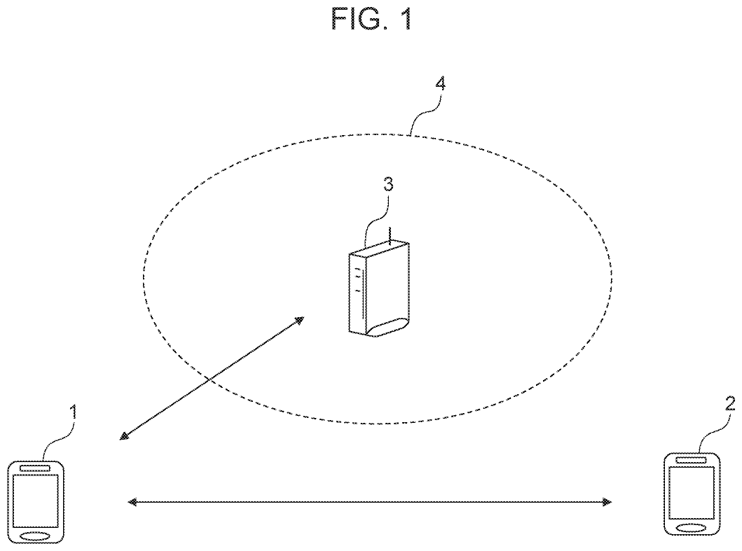

FIG. 1 is a diagram illustrating an example of the network configuration of a communication system according to the present embodiment.

A communication system in FIG. 1 includes wireless terminals 1 and 2, and an access point 3.

The wireless terminal 1 has a wireless LAN (Local Area Network) communication function, and operates as, for example, a configurator specified in DPP. Therefore, the wireless terminal 1 may provide communication parameters for connecting to a wireless LAN network 4 to the wireless terminal 2, and may provide communication parameters for configuring the wireless LAN network 4 to the access point (AP) 3.

The wireless terminal 2 has a wireless LAN communication function, and, for example, is a station (STA) operating as an enrollee specified in DPP. Therefore, the wireless terminal 2 obtains communication parameters from the wireless terminal 1 operating as a configurator, and, on the basis of the obtained communication parameters, connects to the wireless LAN network 4 configured by the AP 3.

The AP 3 operates as, for example, an access point (AP) specified in DPP, and, on the basis of communication parameters provided by the wireless terminal 1, configures the wireless LAN network 4.

The wireless LAN network 4 is, for example, a wireless LAN network configured by the AP 3.

The communication parameters include setting items required for executing wireless communication, such as an SSID (Service Set Identification), which is a network identifier, cryptosystem, encryption key, and authentication method.

The communication parameters also include AKM (Authentication and Key Management). AKM is information that indicates which authentication protocol or key exchange algorithm is used at the time of wireless communication, and is identification information for identifying the type of communication parameters.

For example, if AKM is “dpp”, the communication parameters include a connector which is information for connecting to an AP that supports DPP. This connector includes various types of information used in the authentication protocol or key exchange algorithm defined by DPP.

If AKM is “sae”, the communication parameters include a password which is information for connecting to an AP that does not support DPP. This password is used in WPA (Wi-Fi Protected Access) 3 wireless communication.

If AKM is “psk”, the communication parameters include a PSK (Pre Shared Key)/passphrase which is information for connecting to an AP that does not support DPP. This PSK/passphrase is used in WPA2 wireless communication. The password and the PSK/passphrase are encryption keys for implementing authentication/key exchange based on WPA or IEEE (The Institute of Electrical and Electronics Engineers, Inc.) 802.11.

In FIG. 1, it is only necessary that each wireless terminal in the present embodiment be a device capable of performing wireless communication with another wireless terminal, and each wireless terminal is not limited to that illustrated. A wireless terminal may be another device such as a cellular phone, smartphone, digital camera, PC, camcorder, smart watch, or Personal Digital Assistance (PDA). In addition, although two wireless terminals are illustrated in FIG. 1, the number of wireless terminals is not limited to two, and there may be three or more wireless terminals.

Hardware Configuration of Communication Device

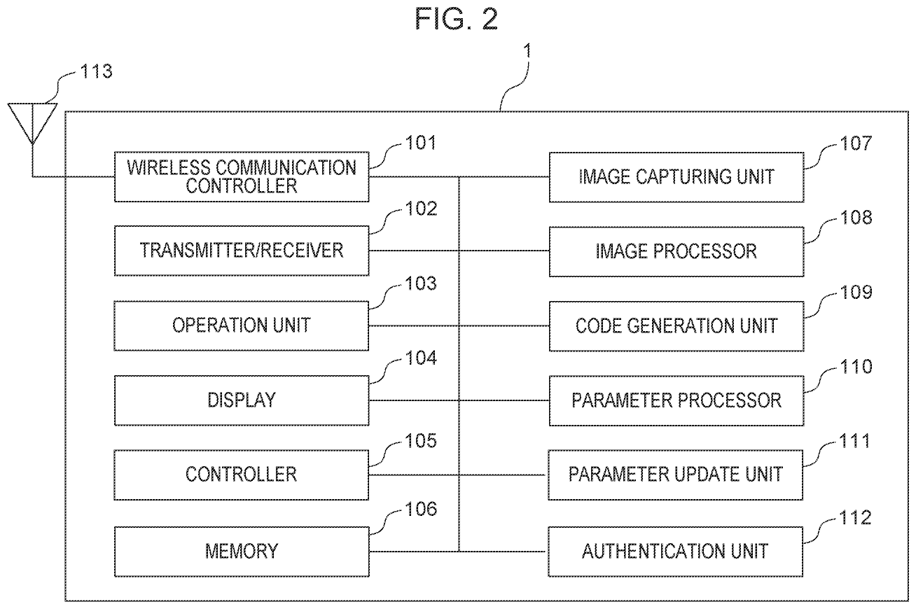

FIG. 2 is a diagram illustrating an example of the hardware configuration and the functional configuration of the wireless terminal 1 according to the present embodiment. Note that the functional configuration of the wireless terminal 2 is the same as the wireless terminal 1.

Each functional unit illustrated in FIG. 2 may be realized by executing, by one or more CPUs (not illustrated), a program stored in a memory 106. That is, each flowchart described later may be realized by executing, by one or more CPUs, a program stored in the memory 106 and executing information calculation and processing and control of each piece of hardware. Note that some or all of the functional units illustrated in FIG. 2 may be realized by dedicated hardware.

The wireless terminal 1 in FIG. 2 includes a wireless communication controller 101, a transmitter/receiver 102, an operation unit 103, a display 104, a controller 105, the memory 106, an image capturing unit 107, and an image processor 108. The wireless terminal 1 further includes a code generation unit 109, a parameter processor 110, a parameter update unit 111, an authentication unit 112, and an antenna 113.

The wireless communication controller 101 applies control to the antenna 113 and a wireless circuit (not illustrated) in order to transmit/receive wireless signals in wireless LAN communication conforming to the IEEE 802.11 series to/from another wireless terminal. The wireless communication controller 101 may be configured by a chip that executes wireless LAN communication.

The transmitter/receiver 102 performs data transmission/reception control according to the protocol of each communication layer via the wireless communication controller 101.

The operation unit 103 is used by the user to operate the wireless terminal 1, and may include a button for activating the image capturing unit 107. Note that the operation unit 103 may be configured by hardware, or may be configured by a UI (User Interface) provided by software using the display 104.

The display 104 is configured by an LCD (Liquid Crystal Display), an LED (Light Emitting Diode), or the like, and performs various types of display processing. The display 104 may have an audio output function, such as a loudspeaker.

The controller 105 is configured to comprehensively control the operation of the wireless terminal 1, and controls the components (101 to 104 and 106 to 112) via a system bus. That is, the controller 105 loads necessary programs from the memory 106 when executing various types of processing, and realizes various functional operations by executing the programs. The controller 105 is configured by, for example, one or more CPUs (Central Processing Units).

The memory 106 stores control programs executed by the controller 105, and various types of data such as image data and communication parameters. Various operations described later are realized by executing, by the controller 105, control programs stored in the memory 106. The memory 106 functions as a main memory or work area for the controller 105, and may include RAM (Random Access Memory) that temporarily stores programs and data. The memory 106 may also include ROM (Read Only Memory), which is a non-volatile memory that stores control programs and parameters requiring no changes, which are needed by the controller 105 to execute various types of processing. The memory 106 may further include an external storage medium, such as an HDD (Hard Disk Drive), flash memory, or detachable SD (Secure Digital) card.

The image capturing unit 107 is configured by an imaging element, lens, and so forth, and executes image capturing of still images and video images. In the present embodiment, the image capturing unit 107 captures an image of one-dimensional code such as barcode or two-dimensional code such as QR code (registered trademark).

The image processor 108 performs image processing of images captured by the image capturing unit 107. In the present embodiment, the image processor 108 analyzes an image of QR code captured by the image capturing unit 107, and decrypts the encrypted information to obtain QR code information.

The code generation unit 109 executes control for generating QR code information of the wireless terminal 1, and displaying the generated QR code information as QR code (image) on the display 104. Although an example in which an image to be read by the image capturing unit 107 is QR code is described in the present embodiment, code information usable in the present embodiment is not limited to QR code, and one-dimensional code such as barcode or other types of two-dimensional code may be used.

The parameter processor 110 performs processing for providing and obtaining communication parameters for connecting to the wireless LAN network 4.

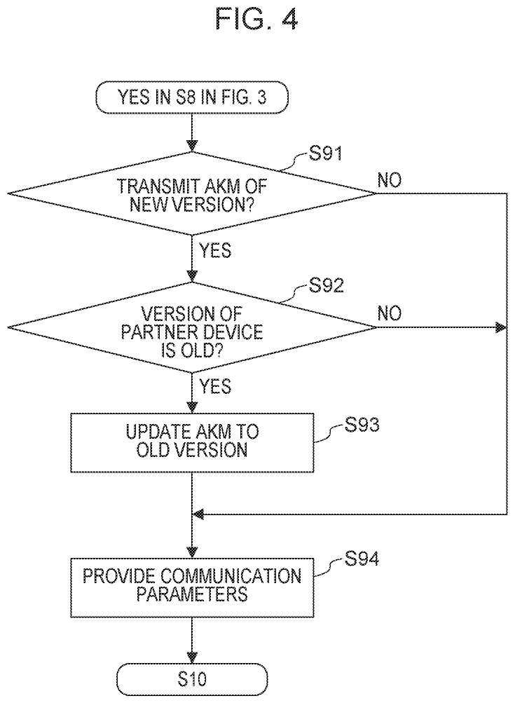

The parameter update unit 111 performs various types of update processing regarding a communication parameter providing process. For example, the parameter update unit 111 updates AKM, which is identification information for identifying communication parameters. In the present embodiment, if an enrollee determines certain AKM as invalid, a configurator updates AKM to be included in communication parameters. A process of setting this updated AKM will be described in detail later with reference to FIG. 4.

The authentication unit 112 performs control (authentication processing) for authenticating another communication device.

The antenna 113 is capable of communicating in the 2.4 GHz band and/or the 5 GHz band for wireless LAN communication.

Note that the above-described functional blocks are only exemplary, and plural functional blocks may configure one functional block, or any functional block may be further separated into plural blocks for performing plural functions.

Communication Parameter Providing Process of Configurator

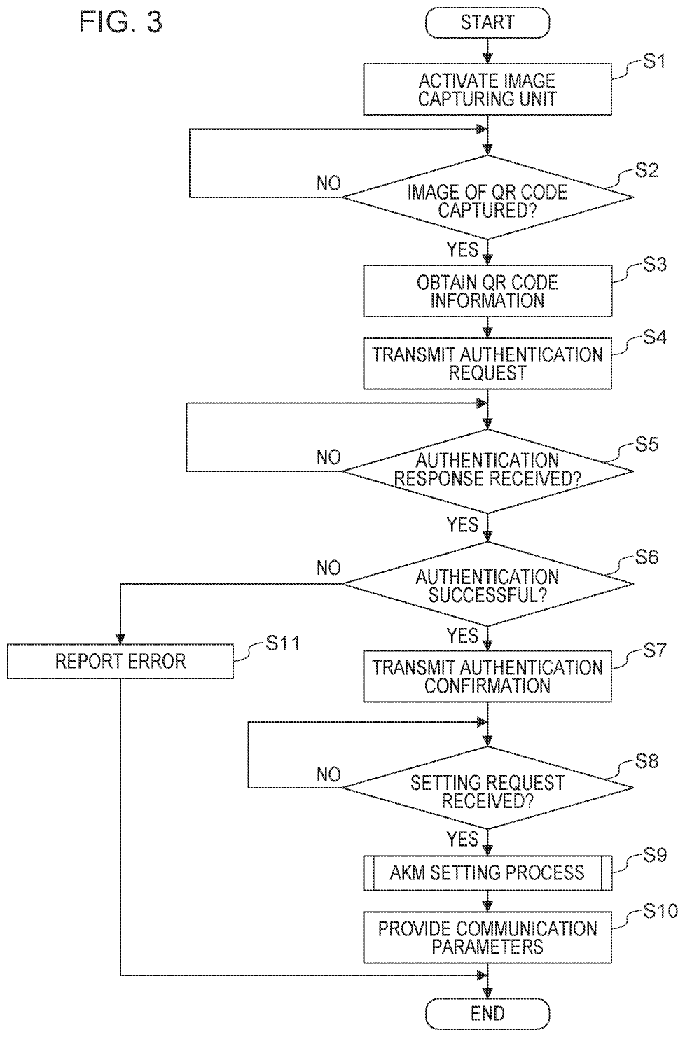

Referring to FIGS. 3 and 4, a process of providing communication parameters specified in DPP in order to allow, by the wireless terminal 1 operating as a configurator, the wireless terminal 2 operating as an enrollee to connect to a wireless network will be described.

In the wireless terminal 1, for example, the communication parameter providing process illustrated in FIG. 3 is activated in response to a trigger which is an input from a user using the operation unit 103 of a command for providing parameters.

In S1, the controller 105 of the wireless terminal 1 activates the image capturing unit 107 in order to capture images including QR code displayed by the wireless terminal 2. An image of QR code captured in S1 includes a public key for authentication of the wireless terminal 2.

In S2, the controller 105 determines whether the image capturing unit 107 has captured an image of QR code. Here, QR code displayed by the wireless terminal 2 is not limited to QR code displayed on the display 104 of the wireless terminal 2, and may be QR code printed on a label attached to the housing or accessory of the wireless terminal 2. Alternatively, QR code may be written on, for example, the instructions of the wireless terminal 2. If no image of QR code is captured within a certain time after the activation of the image capturing unit 107 in S1, the process times out, and the wireless terminal 1 may end the communication parameter providing process.

If it is not determined that an image of QR code has been captured (S2: N), the process returns to S2, and the controller 105 of the wireless terminal 1 waits for an image of QR code to be captured.

In contrast, if it is determined that an image of QR code has been captured (S2: Y), the process proceeds to S3, and the image processor 108 of the wireless terminal 1 obtains, from the captured image of the QR code, QR code information including the public key for authentication of the wireless terminal 2.

In S4, the authentication unit 112 of the wireless terminal 1 transmits an authentication request to the wireless terminal 2 via the transmitter/receiver 102.

The authentication request transmitted in S4 by the wireless terminal 1, which is a configurator, to the wireless terminal 2, which is an enrollee, is, for example, a DPP Authentication Request frame specified in the DPP standard.

This authentication request includes authentication information used in authentication, identification information of the wireless terminal 1, a random number, and a public key for shared key generation. This authentication information may be the hash value of the public key for authentication of the wireless terminal 2, which is included in the QR code obtained in S3. The identification information of the wireless terminal 1 may be the hash value of a public key for authentication of the wireless terminal 1. The random number may be used for authentication on receipt of an authentication response described later. The public key for shared key generation may be a key serving as the generation source of a shared key generated between the wireless terminal 1 and the wireless terminal 2.

On receipt of the authentication request transmitted in S4, the wireless terminal 2 determines whether the device that has transmitted the authentication request is the wireless terminal 1 which has captured the image of the QR code. Determination of whether the device that has transmitted the authentication request is the wireless terminal 1 which has captured the image of the QR code may be performed using authentication information included in the authentication request.

Specifically, the wireless terminal 2 calculates the hash value of the public key included in the QR code displayed on the display 104 of the wireless terminal 2, compares the calculated hash value and the hash value (authentication information) included in the authentication request, and, if the two hash values match, determines that the verification is successful. It is assumed that a hash function used in calculating the hash value here is agreed in advance with the wireless terminal 1 transmitting the authentication request.

After transmitting the authentication request to the wireless terminal 2 in S4, the transmitter/receiver 102 of the wireless terminal 1 waits for reception of an authentication response from the wireless terminal 2 in S5. While no authentication response is received from the wireless terminal 2 (S5: N), the process returns to S5 and an authentication response waiting process is repeated. If no authentication response is received from the wireless terminal 2 within the time, the process times out, and the communication parameter providing process may end.

The authentication response is, specifically, for example, a DPP Authentication Response frame specified in the DPP standard. This authentication response includes a public key for shared key generation, random number, and tag information of the wireless terminal 2.

On receipt of an authentication response from the wireless terminal 2 (S5: Y), in S6, the authentication unit 112 of the wireless terminal 1 verifies the contents of the received authentication response, and determines whether the authentication is successful.

Specifically, at first, the authentication unit 112 of the wireless terminal 1 generates a shared key by using both of the public key for shared key generation of the wireless terminal 2, which is included in the authentication response, and a secret key for shared key generation of the wireless terminal 1 itself. Note that this is a shared key generating method of the wireless terminal 1 operating as a configurator. The wireless terminal 2 operating as an enrollee generates a shared key by using both the public key for shared key generation of the wireless terminal 1, and a secret key for shared key generation of the wireless terminal 2.

A shared key may be generated on the basis of, for example, ECDH (Elliptic Curve Diffie-Hellman). Although it is assumed hereinafter that a shared key be generated on the basis of ECDH, this is not the only possible method, and a shared key may be generated on the basis of other public key cryptosystems.

Following the generation of the shared key, the authentication unit 112 of the wireless terminal 1 determines whether the authentication is successful by using the tag information included in the authentication response. The tag information is, specifically, information obtained by encrypting the random number included in the authentication response transmitted by the wireless terminal 1 with a shared key generated by using both of the secret key for shared key generation of the wireless terminal 2 and the public key for shared key generation of the wireless terminal 1.

The authentication unit 112 of the wireless terminal 1 determines that the authentication is successful in the case where the tag information included in the authentication request has been correctly decrypted with the shared key generated by the wireless terminal 1. The authentication unit 112 of the wireless terminal 1 determines that the authentication is successful in the case where the tag information has been decrypted with the shared key generated by the wireless terminal 1, and determines that the authentication is unsuccessful in the case where the tag information has not been decrypted.

In the case where it is determined in S6 that the authentication is unsuccessful (S6: N), the process branches to S11, and the controller 105 of the wireless terminal 1 displays a message indicating an authentication error on the display 104, and ends the parameter providing process. In contrast, in the case where it is determined that the authentication is successful (S6: Y), the process proceeds to S7, and the authentication unit 112 of the wireless terminal 1 transmits authentication confirmation to the wireless terminal 2 via the transmitter/receiver 102.

The authentication confirmation is, specifically, for example, a DPP Authentication Confirm frame specified in the DPP standard. The authentication confirmation includes tag information. This tag information is one obtained by encrypting the random number, which is included in the authentication response transmitted by the wireless terminal 2, with the generated shared key.

In S8, after transmitting the authentication confirmation in S7, the transmitter/receiver 102 of the wireless terminal 1 waits for a communication parameter setting request to be transmitted from the wireless terminal 2, which is an enrollee.

In contrast, the wireless terminal 2 receives the authentication confirmation transmitted from the wireless terminal 1 in S7, and, in the case where the tag information included in the authentication confirmation is correctly decrypted with the shared key generated by the wireless terminal 2, determines that the authentication is successful.

If it is determined that the authentication is successful, the wireless terminal 2 sets the wireless terminal 1, which has transmitted the authentication request, as a configurator, and transmits a communication parameter setting request to the wireless terminal 1.

The setting request is, specifically, for example, a DPP Configuration Request frame specified in the DPP standard. The setting request includes the device information and role information of the wireless terminal 2. The device information is, for example, the device name of the wireless terminal 2. The role information is information indicating the role after receiving the communication parameters, and is “access point (AP)” or “station (STA)”. Information included in the setting request is encrypted with a shared key used in generating, by the wireless terminal 2, tag information included in the authentication response.

While no setting request is received from the wireless terminal 2 (S8: N), the process returns to S8 and waits for a setting request from the wireless terminal 2. In contrast, on receipt of a setting request from the wireless terminal 2 (S8: Y), the process proceeds to S9.

In S9, the parameter processor 110 and the parameter update unit 111 of the wireless terminal 1 execute a process of setting AKM to communication parameters to be provided to the wireless terminal 2. The process of setting AKM will be described in detail later with reference to FIG. 4.

In S10, the parameter processor 110 of the wireless terminal 1 provides communication parameters to the wireless terminal 2 via the transmitter/receiver 102.

Specifically, the parameter processor 110 of the wireless terminal 1 transmits a setting response including communication parameters for configuring the wireless LAN network 4 to the wireless terminal 2 via the transmitter/receiver 102. This setting response is, for example, a DPP Configuration Response frame specified in the DPP standard. The setting response includes communication parameters, the expiration date of the parameters, a public key dedicated to the wireless terminal 1 as a configurator, and role information. Information included in the setting request is encrypted with the shared key used in generating tag information included in S7.

Note that the communication parameters provided in S10 include a connector, password, PSK/passphrase, and AKM. The wireless terminal 2 operating as an enrollee may determine, on the basis of the value of AKM, whether each of the connector, password, and PSK/passphrase is included in the communication parameters.

After transmitting the setting request, the wireless terminal 2 waits for a setting response to be transmitted from the wireless terminal 1 operating as a configurator. On receipt of the setting response, the wireless terminal 2 decrypts the communication parameters included in the setting response with the shared key used in generating the tag information. The wireless terminal 2 sets therein the communication parameters obtained by the decryption, thereby becoming connectable to the wireless LAN network 4.

Details of AKM Setting Process of Wireless Terminal 1

Next, with reference to FIG. 4, the AKM setting process executed by the wireless terminal 1 in S9 in FIG. 3 will be described in detail.

The case will be considered in which the wireless terminal 1, which supports DPP function extensions, provides communication parameters including AKM added by function extensions to the wireless terminal 2, which does not support DPP function extensions. In this case, because the value of AKM included in the communication parameters is unknown, the wireless terminal 2 determines it as invalid and, as a result, discards the communication parameters, making the wireless terminal 2 unconnectable to the wireless LAN network 4.

In the present embodiment, in order to prevent the wireless terminal 2 from determining the value of AKM as invalid, communication parameters including AKM recognizable by the wireless terminal 2 are provided.

Hereinafter, a process of providing, from the wireless terminal 1 to the wireless terminal 2, communication parameters including AKM updated to be recognizable even by the wireless terminal 2, which does not support DPP function extensions, will be described in the present embodiment.

FIG. 4 is a flowchart illustrating a process of determining, by the wireless terminal 1 which wants to provide communication parameters including AKM added by DPP function extensions, whether the wireless terminal 2 supports function extensions, and providing communication parameters to the wireless terminal 2.

On receipt of a communication parameter setting request in S8 illustrated in FIG. 3 (S8: Y), in S91, the controller 105 of the wireless terminal 1 determines whether AKM included in communication parameters to be provided to the wireless terminal 2 is AKM added by DPP function extensions.

AKM added by function extensions is, for example, a value indicating communication parameters of “WPA4”, which is the successor of WPA3, or a value indicating communication parameters of plural types as in “both DPP and WPA3”.

If it is determined that AKM included in communication parameters to be provided to the wireless terminal 2 is not AKM added by function extensions (S91: N), the process skips S92 and S93 and proceeds to S94. In S94, the parameter processor 110 of the wireless terminal 1 transmits, as a setting response, the communication parameters to the wireless terminal 2 via the transmitter/receiver 102, without changing AKM by the parameter update unit 111.

In contrast, if it is determined that AKM is AKM added by function extensions (S91: Y), the process proceeds to S92, and the controller 105 of the wireless terminal 1 determines whether the wireless terminal 2 supports function extensions. That is, in this step, it is determined which version of DPP is supported by the wireless terminal 2.

Whether the wireless terminal 2 supports function extensions may be determined from, for example, information included in an authentication response or a setting request transmitted by the wireless terminal 2. Specifically, this may be determined on the basis of whether a certain flag bit is set in a certain field of the authentication response or the setting request. Alternatively, this may be determined on the basis of version information indicated by a numeral, such as “1” or “2”, reported by being included in the authentication response or the setting request. It is assumed that the version information includes, besides version information directly indicated by a numeral in the latter case, information on functions supported by the wireless terminal 2 indicated by a flag bit in the former case. In addition, if no information for determining whether the wireless terminal 2 supports function extensions has been received from the wireless terminal 2, it may be determined that the wireless terminal 2 does not support function extensions. For example, it may be determined that the wireless terminal 2 does not support function extensions if the above-mentioned certain field or information indicating the version itself is not included in the authentication response or the setting request.

If it is determined that the version of the wireless terminal 2 is not old and the wireless terminal 2 supports function extensions (S92: N), the parameter processor 110 transmits, as a setting response, the communication parameters to the wireless terminal 2 via the transmitter/receiver 102, without changing AKM by the parameter update unit 111.

In contrast, if it determined that the wireless terminal 2 does not support function extensions (S92: Y), the process proceeds to S93.

In S93, the parameter update unit 111 of the wireless terminal 1 updates AKM included in the communication parameters to an AKM value not added by function extensions, that is, an AKM value supported before function extensions.

In S94, the parameter processor 110 of the wireless terminal 1 transmits, as a setting response, the communication parameters with the updated AKM to the wireless terminal 2 via the transmitter/receiver 102.

Note that the AKM update process specifically updates AKM to either “dpp” or “sae” supported before function extensions in the case where AKM to be transmitted by the wireless terminal 1 is, for example, a value indicating information on plural connection destinations as in “both DPP and WPA3”. In addition, in the case of information on a connection destination whose standard version is identified by a numeral such as “1” or “2” as in WPA, if to-be-transmitted AKM is a value indicating “WPA4” or “both WPA4 and WPA3”, “sae” indicating WPA3, which is the predecessor standard, is selected, and AKM is updated. Alternatively, AKM may always be updated to certain AKM, such as “dpp”, regardless of to-be-transmitted AKM.

Operation Sequence of Communication Parameter Providing Process Between Configurator and Enrollee

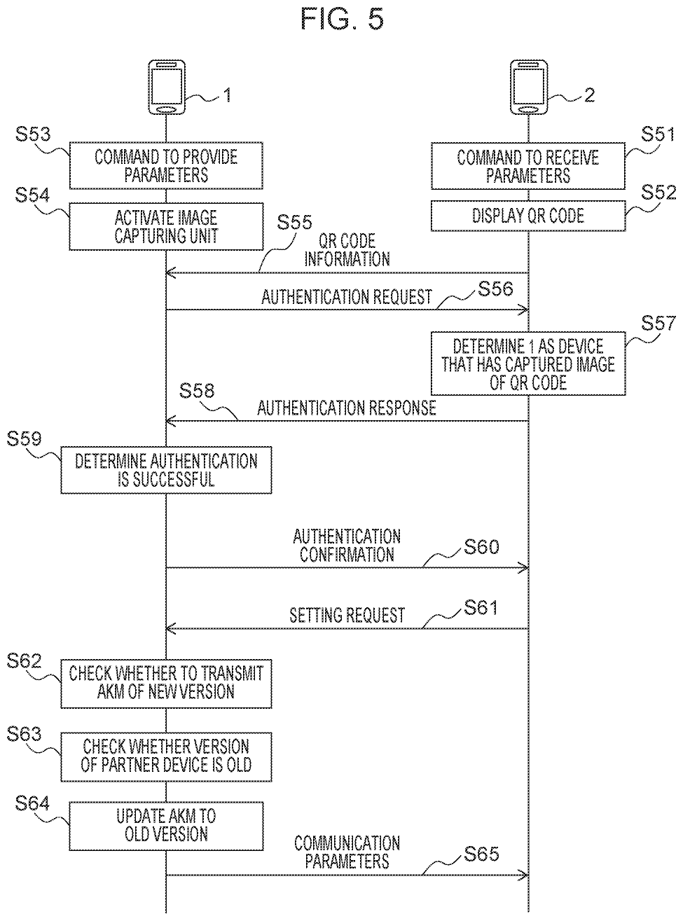

FIG. 5 illustrates an example of the operation sequence of a communication parameter providing process between the wireless terminal 1, which is a configurator, and the wireless terminal 2, which is an enrollee.

In S51, the wireless terminal 2 receives, from a user via the operation unit 103, a command to receive communication parameters.

In S52, the wireless terminal 2 displays QR code on the display 104 and waits for an authentication request from the wireless terminal 1. If no authentication request is received within a certain time, the wireless terminal 2 may end waiting for an authentication request. In addition, the wireless terminal 2 need not include the display 104 for displaying QR code. If QR code is printed on a label attached to the housing or accessory of the wireless terminal 2, S52 may be skipped. In this case, on receipt of a command to receive parameters in S51, the wireless terminal 2 waits for an authentication request without performing the processing in S52.

In contrast, in S53, the wireless terminal 1 receives, from a user via the operation unit 103, a command to provide communication parameters.

In S54, the wireless terminal 1 activates the image capturing unit 107 in order to capture an image of the QR code displayed by the wireless terminal 2.

In S55, the image capturing unit 107 of the wireless terminal 1 captures an image of the QR code displayed by the wireless terminal 2, thereby obtaining QR code information indicated by the QR code.

In S56, the authentication unit 112 of the wireless terminal 1, which has obtained the QR code information indicated by the QR code, generates and transmits an authentication request (DPP Authentication Request) via the transmitter/receiver 102 to the wireless terminal 2, and the wireless terminal 2 receives the authentication request.

In S57, the wireless terminal 2 verifies the contents of the authentication request received from the wireless terminal 1 in S56. The details of a process of verifying the authentication request are as described above with reference to FIG. 3.

In response to verification that the wireless terminal 1, which has transmitted the authentication request, is a device that has captured the image of the QR code, in S58, the wireless terminal 2 generates and transmits an authentication response (DPP Authentication Response) to the wireless terminal 1. The wireless terminal 2, which has transmitted the authentication response to the wireless terminal 1, waits for authentication confirmation to be transmitted from the wireless terminal 1.

In S59, the wireless terminal 1 verifies the contents of the authentication response received from the wireless terminal 2 in S58. The details of a process of verifying the authentication response are as described above with reference to FIG. 3.

In S60, if it is determined that the authentication is successful, the authentication unit 112 of the wireless terminal 1 transmits authentication confirmation (DPP Authentication Confirm) to the wireless terminal 2 via the transmitter/receiver 102.

On receipt of the authentication confirmation from the wireless terminal 1, the wireless terminal 2 verifies the contents of the authentication confirmation. The wireless terminal 2 determines that the authentication is successful in the case where tag information has been correctly decrypted with a shared key generated by the wireless terminal 2.

If it is determined that the authentication is successful, in S61, the wireless terminal 2 transmits a setting request (DPP Configuration Request) in order to perform a communication parameter setting process, and waits for a setting response to be transmitted from the wireless terminal 1.

In S62, the parameter processor 110 of the wireless terminal 1, which has received the setting request from the wireless terminal 2, determines whether to-be-transmitted communication parameters include AKM added by function extensions.

If it is determined that AKM is AKM added by function extensions, in S63, the parameter processor 110 of the wireless terminal 1 determines whether the wireless terminal 2 supports function extensions.

If it is determined that the wireless terminal 2 does not support function extensions, in S64, the parameter update unit 111 of the wireless terminal 1 updates AKM included in the communication parameters to a value of AKM supported before function extensions, that is, AKM recognizable by the wireless terminal 2.

Having updated AKM, in S65, the wireless terminal 1 transmits a setting response (DPP Configuration Response) including the communication parameters including the updated AKM to the wireless terminal 2 via the transmitter/receiver 102. Note that the updated AKM is transmitted by being stored in an AKM field of the setting response.

On receipt of the setting response, the wireless terminal 2 connects to the wireless LAN network 4 using the communication parameters included in the setting response.

With the same or similar processes to those described with reference to FIGS. 3 to 5, the wireless terminal 1, which is a configurator, may provide communication parameters to the access point (AP) 3, which is an enrollee. The AP 3 may configure the wireless LAN network 4 using the communication parameters provided by the wireless terminal 1.

Note that the communication parameter providing process described above is not limited to the order illustrated in each drawing.

For example, before determining whether AKM is AKM added by DPP function extensions (S91 in FIG. 4), the wireless terminal 1 may determine whether the wireless terminal 2 supports function extensions (S92 in FIG. 4). Alternatively, before transmitting authentication confirmation (S7 in FIG. 3), the wireless terminal 1 may determine, on the basis of information included in the received authentication response, whether the wireless terminal 2 supports function extensions. In this case, after receipt of the setting request (S8: Y in FIG. 3), if it is determined that AKM is AKM added by function extensions (S91: Y in FIG. 4), AKM may be updated without determining whether the wireless terminal 2 supports function extensions.

As described above, according to the present embodiment, in the communication parameter providing process, a communication device which is a configurator may provide communication parameters with AKM which is not a value added by function extensions to an enrollee. A communication device which is an enrollee to which communication parameters are provided may normally recognize AKM, thereby effectively preventing a wireless connection failure due to the invalid determination of the communication parameters, resulting in improved convenience of wireless connection.

Although the configuration of exchanging information for setting communication parameters using an image of QR code (registered trademark) between communication devices has been described in the above-described embodiment, this is not the only possible means for providing information including a public key for enrollee authentication.

For example, instead of capturing an image of QR code (registered trademark), wireless communication such as NFC (Near Field Communication) or Bluetooth (registered trademark) may be used. Alternatively, wireless communication such as IEEE 802.11ad or TransferJet (registered trademark) may be used.

Note that to-be-read QR code (registered trademark) is not limited to QR code displayed on a display, but may be QR code attached in the form of a seal or the like to the housing of communication equipment. In addition, to-be-read QR code (registered trademark) may be one attached to the manual or package such as the cardboard box of communication equipment at the time of sale. In addition, not only QR code, but also one-dimensional code such as barcode or other types of two-dimensional code may be used. In addition, instead of machine-readable information such as QR code, information in a user-readable format may be used.

In addition, although the case in which communication between devices is performed by wireless LAN communication conforming to the IEEE 802.11 series has been described in the above-described embodiment, this is not the only possible wireless communication system applicable to the present embodiment. For example, wireless communication may be implemented by using a wireless communication medium such as wireless USB, MBOA (Multi Band OFDM Alliance), Bluetooth (registered trademark), UWB (Ultra Wide Band), ZigBee, or NFC. In addition, UWB includes wireless USB, wireless 1394, and WINET. Although the example in which communication parameters are provided in order to connect to an access point of a wireless LAN has been described in each embodiment, these are not the only possible communication parameters that may be provided in the present embodiment. For example, a communication device may provide communication parameters for connecting to a group owner of Wi-Fi Direct (registered trademark).

In addition, the present invention may be realized by a program realizing one or more functions of the above-described embodiment. That is, the present invention may be realized by a process of supplying the program to a system or device via a network or storage medium, and reading and executing the program by one or more processors included in the system or device (or CPU, MPU, etc.). In addition, the program may be provided by being recorded in a computer-readable recording medium. In addition, the present invention may be realized by a circuit (such as ASIC) realizing one or more functions.

In addition, the above-described embodiment is applicable to a system including a plurality of items of equipment, such as a host computer, interface equipment, image capturing device, and web application, or to a device including a single item of equipment.

The implementation is not limited to realizing the functions of the embodiment by executing the program read by a computer. For example, an operating system (OS) running on the computer performs part or entirety of the actual processing on the basis of instructions of the program, and, with the processing, the functions of the above-described embodiment may be realized.

According to the present invention, a communication parameter of a type according to the version of DPP supported by a partner device may be provided to the partner device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication device comprising:
a first determination unit configured to determine a version of Device Provisioning Protocol (DPP) supported by another communication device;
a second determination unit configured to determine a type of communication parameter to be provided to the another communication device based on the version determined by the first determination unit; and
a providing unit configured to provide information indicating the type determined by the second determination unit and a communication parameter corresponding to the type to the another communication device.

2. The communication device according to claim 1, further comprising:
a receiving unit configured to receive a signal conforming to the DPP standard from the another communication device,
wherein, based on the signal received by the receiving unit, the first determination unit determines a version of DPP supported by the another communication device.

3. The communication device according to claim 2, wherein the signal received by the receiving unit includes information indicating the version of DPP supported by the another communication device.

4. The communication device according to claim 2, wherein, based on a fact that the signal received by the receiving unit does not include a field indicating the version of DPP supported by the another communication device, the first determination unit determines the version of DPP supported by the another communication device.

5. The communication device according to claim 2, wherein the signal received by the receiving unit is a signal requesting a communication parameter from the communication device.

6. The communication device according to claim 1, further comprising:
an authentication unit configured to perform an authentication process for authenticating the another communication device,
wherein, in a case where authentication of the another communication device in the authentication process by the authentication unit is successful, the providing unit provides information indicating the type determined by the second determination unit and a communication parameter corresponding to the type to the another communication device.

7. The communication device according to claim 6, further comprising:
an image capturing unit configured to capture an image of code including information on a public key of the another communication device,
wherein the authentication unit performs the authentication process using the information on the public key included in the code whose image has been captured by the image capturing unit.

8. The communication device according to claim 1, wherein the providing unit encrypts a communication parameter corresponding to the type determined by the second determination unit, and provides the encrypted communication parameter to the another communication device.

9. The communication device according to claim 1, wherein information indicating the type determined by the second determination unit is stored in an AKM (Authentication and Key Management) field, and is provided to the another communication device.

10. The communication device according to claim 9, further comprising:
an update unit configured to update, based on the version determined by the first determination unit, information stored in the AKM field to information indicating the type determined by the second determination unit.

11. The communication device according to claim 1, further comprising:
a decision unit configured to decide, based on the version determined by the first determination unit, whether the providing unit provides a plurality of types of communication parameters or one type of communication parameter to the another communication device.

12. The communication device according to claim 1, wherein the communication device is a configurator conforming to the DPP standard, and the another communication device is an enrollee conforming to the DPP standard.

13. A control method for a communication device, comprising:
a first determination step of determining a version of Device Provisioning Protocol (DPP) supported by another communication device;
a second determination step of determining a type of communication parameter to be provided to the another communication device based on the version determined by the first determination step; and
a providing step of providing information indicating the type determined in the second determination step and a communication parameter corresponding to the type to the another communication device.

14. A computer-readable medium storing a program causing a computer to function as the units of the communication device according to claim 1.
